(19) United States
(12) Patent Application Publication
(10) Pub. No.: US 2026/0241398 A1
(43) Pub. Date: Aug. 20, 2026

(54) Hand-held Paint Sprayer and Method for Operating a Hand-Held Paint Sprayer

(71) Applicant: J. Wagner GmbH, Markdorf (DE)

(72) Inventors: Lukas NEUHAUS, Markdorf (DE); Tino RITTER, Bermatingen (DE)

(21) Appl. No.: 19/164,413

(22) PCT Filed: Mar. 18, 2024
(86) PCT No.: PCT/EP2024/057138

§ 371 Date: Sep. 11, 2025

(30) Foreign Application Priority Data
Mar. 17, 2023 (DE) 10 2023 106 808.3

(51) Int. Cl. B05B 7/24; B05B 7/00; B05B 12/00; B05B 15/40

(52) U.S. Cl. CPC B05B 7/2416; B05B 7/0081; B05B 12/002; B05B 12/006; B05B 15/40

(57) ABSTRACT

A hand-held paint sprayer includes a housing having a handle, a spray head, a fan motor, and an air filter. The paint sprayer includes a pressure sensor for detecting an air pressure. The pressure sensor is arranged between the air filter and the fan motor.

### CROSS-REFERENCE TO RELATED APPLICATIONS

This Application is a Section 371 National Stage Application of International Application No. PCT/EP2024/057138, filed Mar. 18, 2024, and published as WO 2024/194251 A2 on Sep. 26, 2024, and claims priority to German Application No. 102023106808.3, filed Mar. 17, 2023; the contents of these applications are hereby incorporated by reference in their entirety.

### BRIEF DESCRIPTION OF THE DRAWINGS

FIG. 1 shows a perspective view of a hand-held paint sprayer according to one example.

FIG. 2 shows a detailed view of the paint sprayer shown in FIG. 1, wherein components installed on the housing have been removed.

FIG. 3 shows a further detailed view of the paint sprayer shown in FIG. 1 in an exploded view, wherein the filter cover is in the service position and the air filter has been removed.

FIG. 4 shows a further detailed view of the paint sprayer shown in FIG. 1 in an exploded view, wherein only the left-hand side shell of the housing, the control circuit board and the control panel are shown.

FIG. 5 shows a cross section through FIG. 2 according to the cutting plane V and viewed in the direction of the arrow P5.

FIG. 6 shows a detailed view of FIG. 5 in the region VI.

### DETAILED DESCRIPTION

The present disclosure relates to a hand-held paint sprayer and a method for operating a hand-held paint sprayer.

A hand-held paint sprayer which has a housing comprising a handle, a spray head, a fan motor, a filter cover with air supply openings and a filter box with an air filter is disclosed in WO 2023/006861 A1, wherein the paint sprayer comprises a pressurized chamber as a receiving space for the fan motor and wherein the pressurized chamber comprises an air inlet and an air outlet. In principle, in such paint sprayers there is the risk that infiltrated air is sucked in, in particular when operated with a clogged air filter, and the paint sprayer is subjected to greater wear and/or is damaged and/or does not operate optimally due to this unfiltered infiltrated air flowing on uncontrolled paths.

It is an object of the present disclosure to propose a hand-held paint sprayer and a method for operating a hand-held paint sprayer by which the intake of infiltrated air is avoided or the need to change the air filter can be reliably detected.

This object is achieved on the basis of the features described herein.

According to examples of the present disclosure, the hand-held paint sprayer has a housing comprising a handle, a spray head, a fan motor and an air filter, wherein the paint sprayer has a pressure sensor for detecting an air pressure, wherein the pressure sensor is arranged between the air filter and the fan motor. Due to such an arrangement of the pressure sensor, it is possible to establish a change in the air pressure upstream of the fan motor, occurring as a result of an increasingly clogged air filter during operation, so that the need to change the air filter can be signaled or the fan motor can be switched off, if required. Greater wear and damage as a result of a non-optimal operating point are avoided thereby and an optimal operation of the paint sprayer is reliably ensured thereby.

It can also be provided that the paint sprayer comprises a filter cover with air supply openings and a filter box with the air filter and that the paint sprayer comprises a pressurized chamber as a receiving space for the fan motor, wherein the pressurized chamber comprises an air inlet and an air outlet. As a result, the fan motor is received in the paint sprayer such that it has a defined intake side and a defined pressure side and, as a result, undesired secondary flows are avoided during operation.

It can also be provided to arrange the filter box with its air filter opposing the air inlet of the pressurized chamber and to configure a pre-chamber by means of the housing between the pressurized chamber and the filter box, wherein the pre-chamber has air inlet openings which are covered by the air filter toward an outer surface of the housing. As a result, the air filter and the fan motor are optimally positioned relative to one another such that the air flows in a straight line and is not deflected.

It can also be provided to configure in the housing an opening which leads into the pre-chamber, and that the pressure sensor detects a pressure prevailing in the pre-chamber, wherein the pre-chamber forms an airtight antechamber which is exclusively in air exchange with the pressurized chamber and the filter box. Such an arrangement of the pre-chamber between the pressurized chamber and the filter box ensures a configuration of the antechamber as an airtight pre-chamber and a detection of the air pressure prevailing in the pre-chamber, such that correct values are detected for the prevailing air pressure, which values are not changed by an increasing intake of infiltrated air when the air filter is clogged.

It can also be provided to arrange the filter box above the pre-chamber in the region of its air inlet openings located above the air inlet, wherein the filter box comprises an internal volume which corresponds to a volume of the air filter, wherein the filter box is formed by the housing and by the filter cover forming an upper face of the paint sprayer, and wherein the air supply openings of the filter cover at least partially oppose the air inlet. This results in a compact design for an intake unit formed from the filter box and pre-chamber, so that a weight of the hand-held paint sprayer is kept low.

It can also be provided to arrange the opening for the pressure sensor in a recess of the housing which is configured on a rear face of the housing opposing the spray head, wherein the paint sprayer comprises a control circuit board, wherein the control circuit board is received and fixed in the recess, wherein the pressure sensor is arranged on the control circuit board and wherein the pressure sensor (17) is arranged in the region of the opening (19), and the control circuit board bears against the housing such that the opening for the pressure sensor is sealed by the control circuit board. This results in a compact design of the paint sprayer in spite of a spatial assignment of the control circuit board to the pre-chamber, since the control circuit board undertakes the sealing. Moreover, an immediate and direct detection of the pressure prevailing in the pre-chamber takes place, so that an undesired influence on the measurement values as a result of additional components is reliably avoided. Accordingly, the pressure sensor is arranged between the pressurized chamber and the filter box in the flow path of the sucked-in air.

In addition, it can be provided that the control circuit board is configured around the pressure sensor by at least one additional sealing element. The sealing element can be formed, in particular, by a sealing ring preferably having resilient properties, or an adhesive compound.

It can also be provided to connect the filter cover pivotably movably to a control panel and additionally to connect the filter cover to the housing by a latched connection in a closed state. As a result, the filter cover is held captively on the housing and also undertakes the function of stiffening and stabilizing the housing. Moreover, the air filter is reliably pressed thereby against the pre-chamber, so that the filter box does not permit any paths for infiltrated air.

It can also be provided that the paint sprayer is provided with a control panel which is also denoted as a “user interface”, wherein the recess, in which the control circuit board is received, is closed by an/the control panel.

As a result, long connecting cables to the control circuit board can be avoided and also the control panel contributes to a further stiffening and stabilizing of the housing of the paint sprayer.

It can also be provided to configure the control panel together with the control circuit board as a structural unit, wherein the structural unit comprises a setting device which comprises a rotary switch and/or button for selecting one of a plurality of power settings of the fan motor, and wherein the pressure sensor and the setting device are arranged on opposing outer surfaces of the structural unit. This also promotes a compact construction of the paint sprayer.

Moreover, it can also be provided to equip the control panel with a filter change indicator. An intuitive operation or handling of the paint sprayer is facilitated by arranging the setting device and the filter change indicator in the immediate vicinity of one another since, when a process of selecting a power setting is to be undertaken regularly, a user can also automatically see the filter change indicator.

It can also be provided to equip the paint sprayer with a rechargeable battery for supplying the fan motor and to equip the control panel with a battery status indicator for this rechargeable battery. This also results in an intuitive operation or handling of the paint sprayer.

It can also be provided to configure the housing with a left-hand side shell and with a right-hand side shell which bear against one another with congruent contact surface portions to form the housing. As a result, the pressurized chamber can be integrated in a simple manner in the housing without a sufficiently dimensioned supply channel having to be created for the assembly thereof.

It can also be provided to fix the pressurized chamber between the side shells bearing against one another in the housing or to form this pressurized chamber by the side shells bearing against one another. In both cases, a reliable hold of the pressurized chamber in the housing is permanently ensured.

It can also be provided to configure the pre-chamber by a left-hand pocket configured in the left-hand side shell and by a right-hand pocket configured in the right-hand side shell. As a result, the production of the paint sprayer is simplified, since a separate assembly of a pre-chamber is not required. Moreover, an attachment of the pre-chamber to the pressurized chamber can also be implemented by simply joining together the two side shells.

It can also be provided to enable the left-hand side shell with the left-hand pocket to bear with a left-hand arcuate edge portion against a connecting piece of the pressurized chamber and the right-hand side shell with the right-hand pocket to bear with a right-hand arcuate edge portion against the connecting piece of the pressurized chamber and in each case to configure a sealing lip on the connecting piece and/or on both edge portions. As a result, a reliable seal is ensured between the pressurized chamber and the pre-chamber so that an intake of infiltrated air in this region is reliably avoided.

According to one example, the method for operating a hand-held paint sprayer, in particular a paint sprayer as claimed in at least one of claims 1 to 14 which comprises a control circuit board, comprises the steps mentioned below:
an air pressure prevailing between an air filter and a fan motor is repeatedly detected by a pressure sensor,
a pressure difference is repeatedly calculated by a control device of the control circuit board from a first air pressure value detected when the fan motor is at a standstill and a second air pressure value detected when the fan motor is running,
when a predefined pressure difference limit value is reached, a need to change the air filter is signaled to the user,

By means of such a sequence it is possible to detect in a reliable manner the need to change the air filter.

It can also be provided to enable one of a plurality of power settings of the fan motor to be selected by a user by means of a setting device of the control circuit board, wherein a need to change the air filter is signaled to the user when a predefined pressure difference limit value for the respectively adjusted power setting is reached. As a result, even in paint sprayers with a plurality of power settings, the need to change the air filter can be reliably detected by the method, irrespective of the power setting at which it is operated. It is also provided to measure the first air pressure values and the second air pressure values by means of the pressure sensor in an interior of a pre-chamber which is arranged between a filter box with the air filter arranged therein and a pressurized chamber with the fan motor arranged therein. As a result, the pressure sensor can directly and thus correctly detect the air pressure prevailing in the pre-chamber and, as a result, additional components for sealing can be dispensed with. A single pressure sensor is sufficient in order to carry out the monitoring.

It can also be provided to arrange the pressure sensor on the control circuit board and to hold the pressure sensor by the control circuit board in an opening in a wall of the pre-chamber such that the opening is covered by the control circuit board. The assembly is simplified by the direct arrangement of the pressure sensor on the control circuit board.

It can also be provided to detect the first air pressure value, by which the air pressure is detected when the fan motor is at a standstill, in a time window which is between an actuation of a main switch of the paint sprayer and the start-up of the fan motor. It is thus provided, in particular, that the start-up of the fan motor is regulated such that the start-up of the fan motor is triggered by the control device of the control circuit board only when the first air pressure value is detected. The first air pressure value is detected by at least one measurement and, in particular, a plurality of successive measurements. As a result, it is ensured that a first air pressure value is always present.

In the context of the present disclosure, “infiltrated air” is understood to mean air which is sucked in by the fan motor via unintended paths and without prior filtering through the air filter.

Further details of the present disclosure are described in the drawing by way of a schematically shown exemplary embodiment.

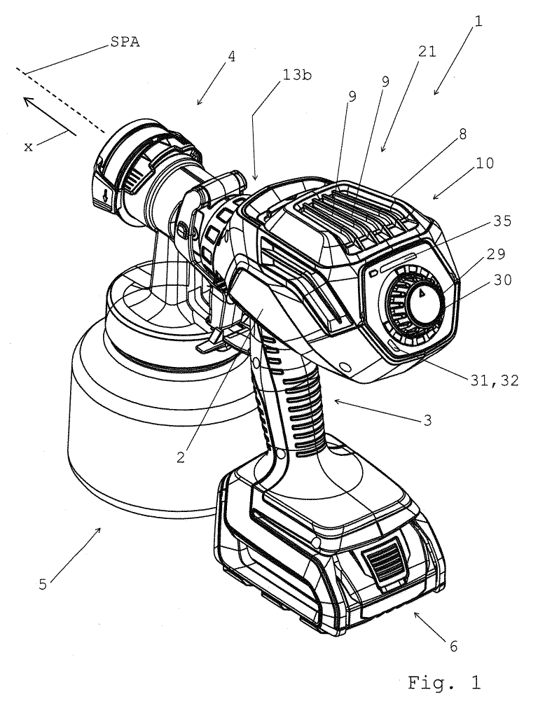

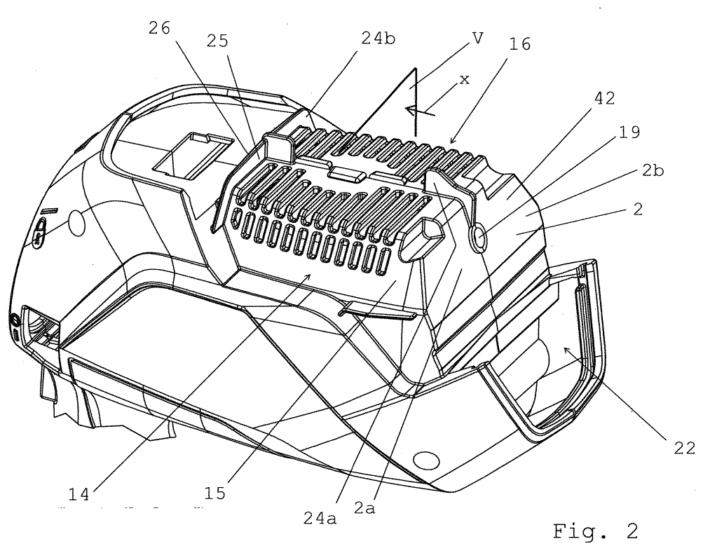

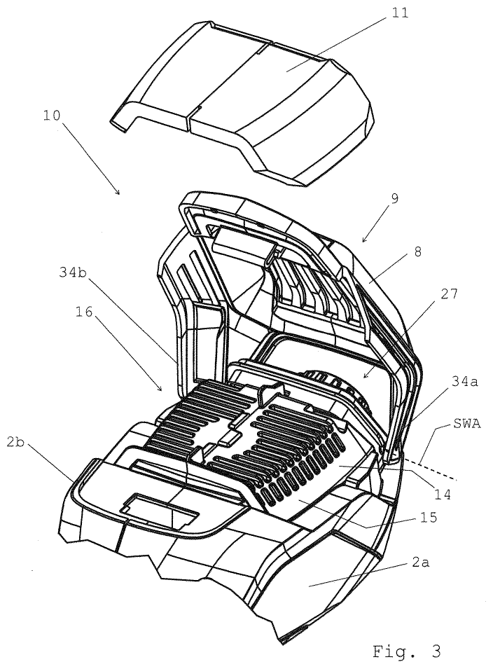

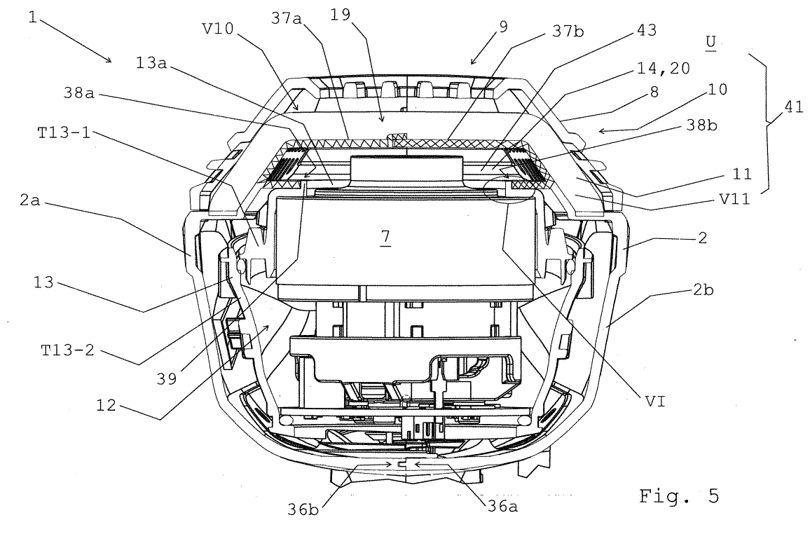

A perspective view of a hand-held paint sprayer 1 according to one example is shown in FIG. 1. Further views and details of this paint sprayer 1 are shown in FIGS. 2 to 6. The paint sprayer 1 has a housing 2 comprising a handle 3, a spray head 4, a paint container 5, a rechargeable battery 6, a fan motor 7 (see FIG. 5) and a filter cover 8 with air supply openings 9, wherein the filter cover 8 together with the housing 2 forms a filter box 10 in which an air filter 11 is received (see FIGS. 2 and 3). The paint sprayer 1 comprises a pressurized chamber 13 as a receiving space 12 for the fan motor 7 (see FIG. 5). The pressurized chamber 13 comprises an air inlet 13a and, toward the spray head 4, an air outlet 13b. The fan motor 7 sucks in air in the region of the air inlet 13a during operation.

The filter box 10 with its air filter 11 opposes the air inlet 13a of the pressurized chamber 13 (see FIG. 5). A pre-chamber 14 is configured by the housing 2 between the pressurized chamber 13, which receives the fan motor 7, and the filter box 10 (see FIG. 5). The pre-chamber 14 has, toward an outer surface 15 of the housing 2, air inlet openings 16 which are covered by the air filter 11 (see FIGS. 2 and 3).

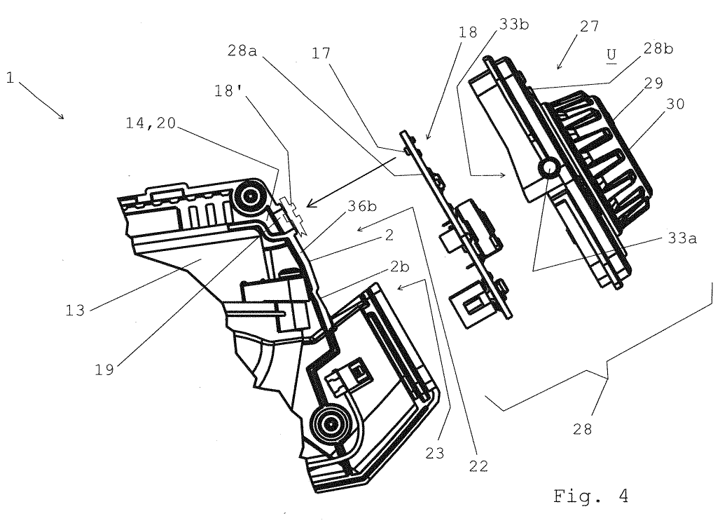

The paint sprayer 1 has a pressure sensor 17 for detecting an air pressure. This pressure sensor 17 is arranged on a control circuit board 18 (see FIG. 4).

An opening 19 which leads into the pre-chamber 14 is configured in the housing 2 (see FIGS. 2 and 4).

In the installed state, the control circuit board 18—as shown schematically in FIG. 4 by a portion of the control circuit board which is sketched by thin lines and which is denoted by 18′—is arranged on the housing 2 such that the pressure sensor 17 is held thereby in the region of the opening 19 and detects an air pressure prevailing in the pre-chamber 14. The pre-chamber 14 forms an airtight antechamber 20 of the pressurized chamber 13, wherein this antechamber 20 is exclusively in air exchange with the pressurized chamber 13 and the filter box 10, and the opening 19 is sealed by the control circuit board 18.

As visible from FIG. 5, the filter box 10 is arranged above the pre-chamber 14 in the region of its air inlet openings 16 located above the air inlet 13a of the pressurized chamber 13. The air inlet openings 16 of the pre-chamber 14 are covered by the air filter 11 received in the filter box 10 so that only filtered ambient air can flow toward the pre-chamber 14.

The filter box 10 has an internal volume V10 which corresponds to a volume V11 of the air filter 11 so that the filter box 10 is entirely filled by the air filter 11 and the air filter cannot slip in the filter box 10. In order to ensure this, the air filter 11 is pressed onto the air inlet openings 16 of the pre-chamber 14 when the filter cover 8 is closed.

The filter box 10 is itself formed by the housing 2 and by the filter cover 8 forming an upper face 21 of the paint sprayer 1.

The air supply openings 9 of the filter cover 8 all oppose the air inlet 13a of the pressurized chamber 13.

The opening 19 in the pre-chamber 14 is arranged in a recess 22 of the housing 2 which is configured on a rear face 23 of the housing 2 opposing the spray head 4. The control circuit board 18 is received in the recess 22 and fixed therein. The control circuit board 18—as described above and shown schematically in FIG. 4—bears against the housing 2, and the opening 19 of the pre-chamber 14, in which the pressure sensor 17 protrudes, is sealed by the control circuit board 18 to form an environment U.

Above the recess 22 of the housing 2 which comprises a left-hand side shell 2a and a right-hand side shell 2b, a first fin 24a is configured on the housing, the air filter 11 being positioned thereby above the air inlet openings 16 of the pre-chamber 14. A second fin 24b, which is T-shaped in plan view and by which the air filter 11 is also positioned, opposes this first fin 24a. Moreover, the T-shaped fin 24b also forms a bearing surface 25 which also forms a side wall 26 of the filter box 10.

The paint sprayer 1 also comprises a control panel 27 (user interface). This control panel 27 is received in the recess 22 in which the control circuit board 18 is also received. The recess 22 is closed by the control panel 27 (see FIG. 1).

The control panel 27 together with the control circuit board 18 forms a structural unit 28. The structural unit 28 comprises as a setting device 29 a rotary switch 30 by which one of a plurality of power settings of the fan motor 7 can be selected for the operation of the paint sprayer 1. A zero power setting is also provided in which the fan motor 7 is switched off. This is implemented by a zero position of the rotary switch 30 or alternatively can be implemented by an on/off switch which is additionally present on the paint sprayer and which forms a main switch. The pressure sensor 17 of the control circuit board 18 and the setting device 29 are arranged on opposing outer surfaces 28a, 28b of the structural unit 28. Alternatively, according to a variant which is not shown, buttons can also be provided instead of a rotary switch for selecting the power settings.

The control panel 27 also comprises a filter change indicator 31. This comprises a light-emitting diode 32 which is illuminated green as long as the air filter 11 permits a sufficient air supply to the fan motor 7 during the operation of the paint sprayer 1 and which is illuminated red when the fan motor 7 is no longer supplied with sufficient air by the air filter 11 during the operation of the paint sprayer 1.

The filter cover 8 is pivotably movably connected to the control panel 27 and in its closed state, which is shown in FIG. 1, is additionally connected to the housing by a latched connection (see FIGS. 1, 3 and 4). The control panel 27 has two laterally arranged opposing receivers 33a, 33b (see FIG. 4) in which in each case an arm 34a, 34b of the filter cover 8 is pivotably guided about a pivot axis SWA (see FIG. 3) located transversely to a spray axis SPA (see FIG. 1).

The fan motor 7 is driven by the rechargeable battery 6 and the control panel 27 also comprises a battery status indicator 35 for this rechargeable battery 6 (see FIG. 1).

The left-hand side shell 2a and the right-hand side shell 2b bear against one another with congruent contact surface portions 36a, 36b to form the housing 2 and are additionally positively connected together (see in particular FIGS. 4 and 5).

The pre-chamber 14 is formed by a left-hand pocket 37a configured in the left-hand side shell 2a (see FIG. 5—cross-hatched lines) and by a right-hand pocket 37b configured in the right-hand side shell 2b (see FIG. 5—cross-hatched lines). In the section shown in FIG. 5, which runs according to the cutting line V shown in FIG. 2 and is viewed in the spraying direction x (see FIG. 1), the two pockets 37a and 37b are indicated by the above-mentioned hatched lines of the cut surfaces. To maintain clarity, the remaining cut surfaces of FIG. 5 are not shown in hatched lines.

The pressurized chamber 13, which is formed by an upper pot T13-1 and a lower pot T13-2 and receives the fan motor 7, is fixed between the side shells 2a, 2b bearing against one another in the housing 2. According to a variant, not shown, the pressurized chamber itself can also be formed in a comparable manner to the pre-chamber by the side shells bearing against one another. These side shells are then accordingly configured in each case with a further pocket, these two further pockets then forming the pressurized chamber and receiving the fan motor when the half side shells are assembled together.

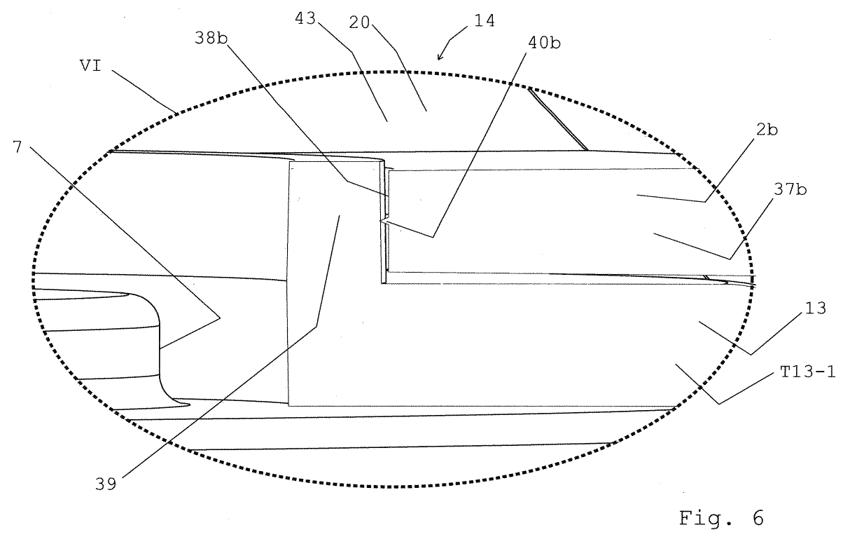

As is also visible in the detailed view of FIG. 6 which shows an enlarged region denoted in FIG. 5 by VI, the right-hand side shell 2b with the right-hand pocket 37b bears with a right-hand arcuate edge portion 38b against a connecting piece 39 of the pressurized chamber 13 and the left-hand side shell 2a with the left-hand pocket 37a bears with a left-hand arcuate edge portion 38a against the connecting piece 39 of the pressurized chamber 13, wherein a sealing lip 40b is configured on each of the edge portions 38a, 38b. The assembled side shells 2a, 2b encompass the connecting piece 39 in an annular manner so that a peripheral seal is provided. According to variants, not shown, it can also be provided to configure a sealing lip on the connecting piece of the pressurized chamber or to configure sealing lips both on the connecting piece and on the arcuate edge portions, wherein these sealing lips are arranged offset to one another such that a double seal is achieved.

The filter box 10 with the air filter 11 and the pre-chamber 14 form an intake unit 14. This intake unit is sealingly designed with the exception of the air supply openings 9 of the filter cover 8 and sealingly attached to the pressurized chamber 13, such that the fan motor 7 can also exclusively suck in air at its maximum power from the filter box 10 through the air filter 11. It is avoided thereby that infiltrated air is drawn in and it is avoided thereby that the housing is internally contaminated by infiltrated air flowing through and the components installed in the housing are contaminated.

For operating the hand-held paint sprayer 1 which comprises the fan motor 7, the pressurized chamber 13, the pre-chamber 14, the filter box 10 with the air filter 10 arranged therein and the control circuit board 18, the following steps are provided:
the pre-chamber 14 is arranged between the filter box 10 and the pressurized chamber 14 and during the operation of the paint sprayer 1 is flowed through by air which is sucked in by the fan motor 7 through the air filter 11 from an environment U;
air pressure prevailing in an interior 43 of the pre-chamber 14 is repeatedly detected;
one of a plurality of power settings of the fan motor 7 is selected by a user by means of the setting device 29 of the control circuit board 17;
a pressure difference is repeatedly calculated by a control device 44 of the control circuit board 17 from a first air pressure value detected when the fan motor 7 is at a standstill and a second air pressure value detected when the fan motor 7 is running;
when a predefined pressure difference limit value for each adjustable power setting is reached, a need to change the air filter 11 is signaled to the user.

It is provided to detect the first pressure value, by which the air pressure is detected when the fan motor 7 is at a standstill, in a time window which is between an actuation of a main switch of the paint sprayer 1 and a start-up of the fan motor 7. It is provided that the start-up of the fan motor 7 is regulated such that the start-up of the fan motor 7 is triggered by the control device 44 of the control circuit board 18 only when the first air pressure value is detected. The first air pressure value is detected by at least one measurement and, in particular, a plurality of successive measurements.

The air pressure prevailing in the interior 43 of the pre-chamber 14 is detected by the control circuit board 18 by means of the pressure sensor 17 arranged thereon, wherein the pressure sensor 17 is held to this end by the control circuit board 18 in the opening 19 in the wall 42 of the pre-chamber 14 and the opening 19 is sealed by the control circuit board 18.

In principle, the value of the pressure difference between the first air pressure value, which has been measured when the fan motor 7 is at a standstill, and each second air pressure value, which has been measured when the fan motor 7 is running, becomes greater as the air filter 11 becomes increasingly clogged. The corresponding maximum pressure difference limit values for each power setting of the paint sprayer 1 are stored in the control device 44.

Although the present invention has been described with reference to preferred embodiments, workers skilled in the art will recognize that changes may be made in form and detail without departing from the spirit and scope of the invention.

### LIST OF REFERENCE SIGNS

1 Paint sprayer
2 Housing of 1
2a Left-hand side shell of 2
2b Right-hand side shell of 2
3 Handle of 1
4 Spray head of 1
5 Paint container of 1
6 Rechargeable battery of 1
7 Fan motor
8 Filter cover
9 Air supply opening of 8
10 Filter box
11 Air filter
12 Receiving space
13 Pressurized chamber
13a Air inlet of 13
13b Air outlet of 13
14 Pre-chamber
15 Outer surface of 2
16 Air inlet opening of 14
17 Pressure sensor
18 Control circuit board
19 Opening in 14
20 Antechamber
21 Upper face of 1
22 Recess in 2
23 Rear face of 2
24a First fin at 2
24b Second T-shaped fin at 2
25 Bearing surface formed by 24b
26 Side wall formed by 24b
27 Control panel
28 Structural unit formed from 18 and 27
28a First outer surface of 28
28b Second outer surface of 28
29 Setting device
30 Rotary switch as 29
31 Filter change indicator of 27
32 Light-emitting diode
33a, 33b Receiver at 27 for 34a, 34b
34a, 34b Arm of 8
35 Battery status display
36a, 63b Contact surface portion of 2a, 2b
37a, 37b Pocket in 2a, 2b
38a Left-hand arcuate edge portion of 37a
38b Right-hand arcuate edge portion of 37b
39 Connecting piece of 14
40b Sealing lip at 38b
41 Intake unit
42 Wall of pre-chamber
43 Interior of pre-chamber
44 Control device
SPA Spray axis of 1
SWA Pivot axis of 8 at 2
T13-1 Upper pot of 13
T13-2 Lower pot of 13
U Environment
V10 Internal volume of 10
V11 Volume of 11
x Spraying direction

1. A hand-held paint sprayer having
a housing comprising a handle,
a spray head
a fan motor,
an air filter, wherein the hand-held paint sprayer has a pressure sensor for detecting an air pressure, wherein the pressure sensor is arranged between the air filter and the fan motor.

2. The hand-held paint sprayer as claimed in claim 1, wherein
the hand-held paint sprayer comprises a filter cover with air supply openings and a filter box with the air filter,
the hand-held paint sprayer comprises a pressurized chamber as a receiving space for the fan motor, and
the pressurized chamber comprises an air inlet and an air outlet.

3. The hand-held paint sprayer as claimed in claim 2, wherein
the filter box with the air filter opposes the air inlet of the pressurized chamber and a pre-chamber is configured by the housing between the pressurized chamber and the filter box, and
the pre-chamber has air inlet openings which are covered by the air filter toward an outer surface of the housing.

4. The hand-held paint sprayer as claimed in claim 3, wherein
an opening which leads into the pre-chamber is configured in the housing,
the pressure sensor detects a pressure prevailing in the pre-chamber, and
the pre-chamber forms an airtight antechamber which is exclusively in air exchange with the pressurized chamber and the filter box.

5. The hand-held paint sprayer as claimed in claim 3, wherein
the filter box is arranged above the pre-chamber in the region of the air inlet openings located above the air inlet,
the filter box comprises an internal volume which corresponds to a volume of the air filter,
the filter box is formed by the housing and by the filter cover forming an upper face of the paint sprayer, and
the air supply openings of the filter cover at least partially oppose the air inlet.

6. The hand-held paint sprayer as claimed claim 4, wherein
the opening is arranged in a recess which is configured on a rear face of the housing opposing the spray head,
the paint sprayer comprises a control circuit board,
the control circuit board is received and fixed in the recess,
the pressure sensor is arranged on the control circuit board,
the pressure sensor is arranged in the region of the opening, and
the control circuit board bears against the housing such that the opening is sealed by the control circuit board.

7. The hand-held paint sprayer as claimed in claim 1, wherein
the filter cover is pivotably movably connected to a control panel, and
the filter cover is additionally connected to the housing by a latched connection in a closed state.

8. The hand-held paint sprayer as claimed in claim 6, wherein the paint sprayer comprises a control panel, wherein the recess, in which the control circuit board is received, is closed by the control panel.

9. The hand-held paint sprayer as claimed in claim 8, wherein the control panel together with the control circuit board forms a structural unit, wherein the structural unit comprises a setting device for selecting one of a plurality of power settings of the fan motor, and wherein the pressure sensor and the setting device are arranged on opposing outer surfaces of the structural unit.

10. The hand-held paint sprayer as claimed in claim 8, wherein
the control panel also comprises a filter change indicator, and/or
the paint sprayer for supplying the fan motor comprises a rechargeable battery and the control panel comprises a battery status indicator for this rechargeable battery.

11. The hand-held paint sprayer as claimed in claim 4, wherein the housing comprises a left-hand side shell and a right-hand side shell which bear against one another with congruent contact surface portions to form the housing.

12. The hand-held paint sprayer as claimed in claim 11, wherein the pressurized chamber is fixed between the side shells bearing against one another in the housing or is formed by the side shells bearing against

13. The hand-held paint sprayer as claimed in claim 11, wherein the pre-chamber is formed by a left-hand pocket configured in the left-hand side shell and by a right-hand pocket configured in the right-hand side shell.

14. The hand-held paint sprayer as claimed in claim 13, wherein
the left-hand side shell with the left-hand pocket bears with a left-hand arcuate edge portion against a connecting piece of the pressurized chamber,
the right-hand side shell with the right-hand pocket bears with a right-hand arcuate edge portion against the connecting piece of the pressurized chamber, and
each case a sealing lip is configured on the connecting piece and/or on both edge portions.

15. A method for operating a hand-held paint sprayer which comprises a control circuit board, the method comprising:
repeatedly detecting, by a pressure sensor, an air pressure prevailing between an air filter and a fan motor;
repeatedly calculating, by a control device of a control circuit board, a pressure difference from a first air pressure value detected when the fan motor is at a standstill and a second air pressure value detected when the fan motor is running; and
when a predefined pressure different limit value is reached, signaling to a user a need to change the air filter.

16. A method for operating a hand-held paint sprayer as claimed in claim 15, further comprising:
selecting, by a user through a setting device of the control circuit board, one of a plurality of power settings of the fan motor; and
when a predefined pressure difference limit value for a respectively adjusted power setting is reached, signaling a need to change the air filter to the user.

17. The method for operating a hand-held paint sprayer as claimed in claim 15, wherein the first air pressure values and the second air pressure values are measured by the pressure sensor in an interior of a pre-chamber which is arranged between a filter box with the air filter arranged therein and a pressurized chamber with the fan motor arranged therein.

18. The method as claimed in claim 17, wherein the pressure sensor is arranged on the control circuit board and is held by the control circuit board in an opening in a wall of the pre-chamber such that the opening is sealed by the control circuit board.

19. The method as claimed in claim 15, wherein the first air pressure value, by which the air pressure is detected when the fan motor is at a standstill, is detected in a time window which is between an actuation of a main switch of the paint sprayer and the start-up of the fan motor.

20. The method as claimed in claim 19, wherein the start-up of the fan motor is triggered by the control device of the control circuit board only when the first air pressure value is detected, and the first air pressure value is detected by at least one measurement.
